(19) United States
(12) Patent Application Publication
(10) Pub. No.: US 2022/0288452 A1
(43) Pub. Date: Sep. 15, 2022

(54) VISUAL SUPPORT SYSTEM FOR EXERCISE COMPLIANCE

(71) Applicant: The Motion Project, LLC, Springfield, MA (US)

(72) Inventors: Christopher Sims, Amherst, MA (US); Christopher Bignell, East Longmeadow, MA (US)

(21) Appl. No.: 17/634,004

(22) PCT Filed: Aug. 13, 2020
(86) PCT No.: PCT/US20/46169

§ 371 Date: Feb. 9, 2022

Related U.S. Application Data
(60) Provisional application No. 62/887,155, filed on Aug. 15, 2019.

(51) Int. Cl. A63B 24/00; G06T 7/246

(52) U.S. Cl. CPC A63B 24/0006; G06T 7/248; A63B 2024/0012; G06T 2207/20221

(57) ABSTRACT

Aspects are directed to visual support for exercise compliance including capturing, via a camera of a user device, images of a first person performing one or more motions. Previously recorded images of a second person performing the one or more motions are accessed via the user device. Combined images are created by overlaying the images of the first person performing the one or more motions on the images of the second person performing the one or more motions. The combined images are output via a display device.

### CROSS-REFERENCE TO RELATED APPLICATION

This application claims the benefit of U.S. Provisional Application No. 62/887,155, filed Aug. 15, 2019, and entitled “Visual Support System for Exercise Compliance”, the content of which is incorporated herein by reference in its entirety.

### BACKGROUND

The present invention generally relates to exercise compliance, and more specifically to mechanisms to improve the compliance and efficacy of exercise programs in rehabilitation, sports training, and fitness.

Exercise programs, whether supervised or done independently, are a key component of rehabilitation, sport-specific training, and general fitness. Traditionally, supervised programs are designed by a coach or clinician who oversees some workouts directly, then lets the client do the remaining work on their own.

There are a variety of tools available to support both clinical and independent workouts. Some use sensors or other hardware to track the client's physical movement, providing a high-fidelity representation of their motion for human or computer analysis. Since these require specific equipment, which is often expensive and complex to operate, they are often found in clinical settings or dedicated training facilities where they are used under the direction of a clinician or coach and shared by many clients. These hardware tools are unsuitable for individual clients to use in home workouts due to their expense and operational complexity.

Other tools itemize a recommended workout and illustrate correct motion technique by example, such as video libraries and text/image workout guides. These show clients how individual motions should be accomplished. Since clients typically find it difficult to replicate a motion after watching another person do it, these guides are of limited use in teaching technique. They also offer no compliance mechanism, leaving the client to self-report what exercise they did and how well they did it.

Other tools use pose recognition algorithms to highlight a client's pose, with lines connecting major body joints, as they perform a motion. This approach is difficult for clients to visually follow, since they are comparing an actual image of themselves with a computer-rendered abstraction of their skeleton. It also offers inadequate information, since seeing an abstraction of their own pose does not show the client what they should be doing. These tools lack the visual information required by a typical client to correctly follow a motion.

### SUMMARY

Embodiments of the present invention are directed to visual support for exercise compliance. A non-limiting example method includes capturing, via a camera of a user device, images of a first person performing one or more motions. Previously recorded images of a second person performing the one or more motions are accessed via the user device. Combined images are created by overlaying the images of the first person performing the one or more motions on the images of the second person performing the one or more motions. The combined images are output via a display device.

In addition to one or more of the features described above or below, or as an alternative, further embodiments of the method may include that the one or more motions include a plurality of sequential stages, that a first image in the images of the first person performing the one or more motions and a second image in the images of the second person performing the one or more motions correspond to a same stage of the plurality of sequential stages, and that a combined image of the combined images includes the first image overlaid on the second image.

In addition to one or more of the features described above or below, or as an alternative, further embodiments of the method may include the overlaying including matching a body point on the first person to a same body point on the second person

In addition to one or more of the features described above or below, or as an alternative, further embodiments of the method may include that the body point is a joint.

In addition to one or more of the features described above or below, or as an alternative, further embodiments of the method may include that the one or more motions include an exercise.

In addition to one or more of the features described above or below, or as an alternative, further embodiments of the method may include that the creating is performed in real-time and overlaps with the capturing.

In addition to one or more of the features described above or below, or as an alternative, further embodiments of the method may include that the images are in a video format.

In addition to one or more of the features described above or below, or as an alternative, further embodiments of the method may include selecting a subset of the combined images for review by a third person.

In addition to one or more of the features described above or below, or as an alternative, further embodiments of the method may include automatically comparing locations of the images of the first person and the second person in the combined images to measure a quality of the one or more motions by the first person.

In addition to one or more of the features described above or below, or as an alternative, further embodiments of the method may include creating images of a new motion and adding the new motion to the one or more motions.

Embodiments of the present invention are directed to a visual support for exercise compliance. A non-limiting example method includes receiving a first plurality of images of a first person performing a motion. The motion in the first plurality of images is compared to an expected motion. A difference between the motion in the first plurality of images and the expected motion is determined, and a compliance score is generated for the motion based at least in part on the determined difference.

In addition to one or more of the features described above or below, or as an alternative, further embodiments of the method may include that the expected motion is described in a second plurality of images and the comparing includes overlaying the first plurality of images with the second plurality of images.

In addition to one or more of the features described above or below, or as an alternative, further embodiments of the method may include that a stick figure in the second plurality of images is overlaid onto the first person in the first plurality of images

In addition to one or more of the features described above or below, or as an alternative, further embodiments of the method may include that locations of joints in the stick figure in the second plurality of images are compared to locations of corresponding joints in the first person in the first plurality of images.

In addition to one or more of the features described above or below, or as an alternative, further embodiments of the method may include updating the expected motion based at least in part of the compliance score.

In addition to one or more of the features described above or below, or as an alternative, further embodiments of the method may include that the comparing and determining are performed on only a subset of the first plurality of images

In addition to one or more of the features described above or below, or as an alternative, further embodiments of the method may include generating a report that includes at least a subset of the first plurality of images for review by a practitioner via a display.

In addition to one or more of the features described above or below, or as an alternative, further embodiments of the method may include the report further includes a second plurality of images illustrating the expected motion overlaid on the at least a subset of the first plurality of images.

Other embodiments of the present invention implement features of the above-described methods in computer systems and computer program products.

Technical effects of embodiments of the present disclosure include a novel set of mechanisms to provide real-time visual clinical and independent workout support, and later review of these workouts, without requiring specialized hardware beyond broadly available computing devices such as mobile phones, tablets, or laptop/desktop computers.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of a visual support system for exercise compliance according to one or more embodiments of the present invention;

FIG. 2 depicts a flow diagram of a method for providing visual support for exercise compliance according to one or more embodiments of the present invention;

FIG. 3 depicts an interface for a practitioner to create or update a client workout program according to one or more embodiments of the present invention;

FIG. 4 depicts an interface for a practitioner to create a new motion according to one or more embodiments of the present invention;

FIG. 5 depicts an interface for a practitioner to add a video of one repetition of a motion, which can then be used iteratively to display that motion according to one or more embodiments of the present invention;

FIG. 6 depicts an interface where the client can see their assigned workout program and initiate a workout according to one or more embodiments of the present invention;

FIG. 7 depicts a flow diagram of a method for performing visual workout support according to one or more embodiments of the present invention;

FIG. 8 depicts a visual guide for a client to follow when performing a motion according to one or more embodiments of the present invention;

FIG. 9 depicts a flow diagram of a method for performing analytic measurement of motion correctness according to one or more embodiments of the present invention;

FIG. 10 depicts a flow diagram of a method for performing clinician or coach review of a client workout according to one or more embodiments of the present invention;

FIG. 11 depicts a report that includes workout status for multiple users according to one or more embodiments of the present invention;

FIG. 12 depicts a time lapsed view of a client's workout according to one or more embodiments of the present invention;

FIG. 13 depicts a cloud computing environment according to one or more embodiments of the present invention;

FIG. 14 depicts abstraction model layers according to one or more embodiments of the present invention; and

FIG. 15 illustrates a system for secure ingress and egress for data engines according to one or more embodiments of the present invention.

The diagrams depicted herein are illustrative. There can be many variations to the diagrams, or the operations described therein without departing from the spirit of the invention. For instance, the actions can be performed in a differing order or actions can be added, deleted or modified. Also, the term “coupled” and variations thereof describe having a communications path between two elements and do not imply a direct connection between the elements with no intervening elements/connections between them. All of these variations are considered a part of the specification.

### DETAILED DESCRIPTION

One or more embodiments of the present invention provide a tool that can be utilized by both practitioners and clients to improve the compliance and efficacy of exercise programs in rehabilitation, sports training, and fitness. One or more embodiments of the present invention provide a visual support system for exercise compliance. A novel set of mechanisms described herein provide real-time visual clinical and independent workout support, and later review of these workouts, without requiring specialized hardware beyond broadly available computing devices such as mobile phones, tablets, or laptop/desktop computers.

As used herein, the term “practitioner” refers to a coach, clinician, personal trainer, or other supervisory figure supporting the client's training. It also includes the client acting in this role on their own behalf. Any of the terms specifying a particular type of practitioner, such as coach or trainer, include the other types, without limitation. As used herein, the term “user” or “client” refers to the person performing the motions, or exercises, that are being monitored and/or evaluated by the practitioner.

In accordance with one or more embodiments of the present invention, a coach or clinician, or a client acting in this role, creates or updates a workout program for the client. The client sees their assigned workout (e.g., via display on a user device), and while doing these or other motions receives real-time visual guidance on whether they are executing the motions correctly by watching how their motions compare in real time to a reference figure, optionally supplemented by computer pose estimation of the client or the reference motion. The client performing the workout is captured in time lapsed image format for later review by the client and/or their coach or clinician, and can be automatically scored for motion quality, using the distance between body points of the client and reference motion at each point as a basis for comparison.

In accordance with one or more embodiments of the present invention, a coach or clinician can create a new motion for later use in client workouts, recording a video of one repetition of that motion which can be repeated iteratively to form exercise sets.

One or more embodiments of the present invention can be implemented on broadly available computing devices (e.g. phones, tablets, desktops, or laptops) and can perform one or more of the following: real-time video overlay of reference motion and live client; option to add real-time video overlay of computer pose estimation, of client and/or reference, as an additional visual guide; time lapsed photos of executed motion for practitioner review; automatic comparison of computer pose estimations of client and reference figures, using distance between body points as a basis for analytics measuring the quality of client's motion; creation of new motion from video capture (and cropping) of one repetition which can later be looped an arbitrary number of times for display of multiple repetitions; and the ability to overlay computer pose estimation on time lapsed activity photos, showing either the client and/or the reference, to aid in practitioner or client review.

One or more embodiments of the present invention are contrasted with contemporary approaches which require specialized hardware, such as a game console or wearable sensors, which limits where they can be deployed. One or more embodiments of the present invention only require the capabilities of broadly available computing devices, using the camera for input and the display screen for output, which makes it practical for widespread remote use outside of a clinical environment.

Contemporary approaches provide clients with paper printouts describing the assigned motions, or with links to video examples displaying these motions being done by a trainer. These options offer limited support to the client, since most clients find it difficult to translate these materials correctly into their own motion. This is contrasted with one or more embodiments of the present invention which provide real-time visual guidance to the client, using an overlaid image of a trainer for them to follow. This gives the client a clear comparison of their own motion with the correct motion, removing the need for the client to translate.

Contemporary approaches do not allow for practitioner review of a client performing a workout and thus, the client is on their own in terms of performing the workout and in assessing the correctness of the motions performed during the workout. Embodiments of the present invention described herein provide for practitioner/client interaction, thereby establishing an accountability mechanism. The filmstrips generated by one or more embodiments of the present invention provide for real-time review to assist practitioners in their analysis and course of care decision making. Practitioners do not have to watch an entire video of a client workout (e.g., a 30 or 60 minute video) to ensure that the client has performed their workout correctly. Instead, the practitioners can review the filmstrips in minutes. In addition, to practitioner review, one or more embodiments of the present invention provide clients with automated motion quality feedback using computer pose estimation, comparing the distance of their body parts with the reference motion.

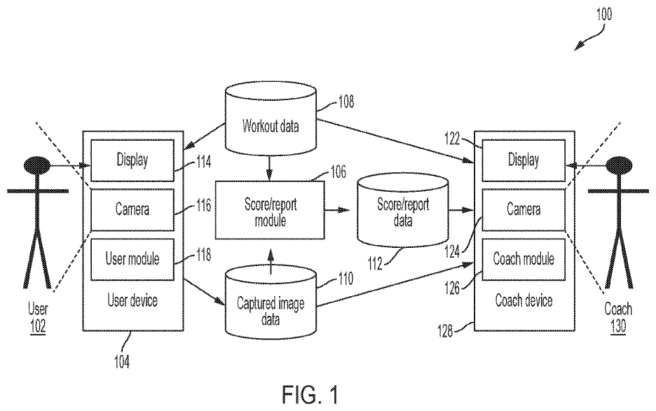

Turning now to FIG. 1, a block diagram 100 of a visual support system for exercise compliance is generally shown in accordance with one or more embodiments of the present invention. The components in FIG. 1 include a user device 104, a score/report module 106, a coach device 128, workout data 108, captured image data 110, and a score/report data 112.

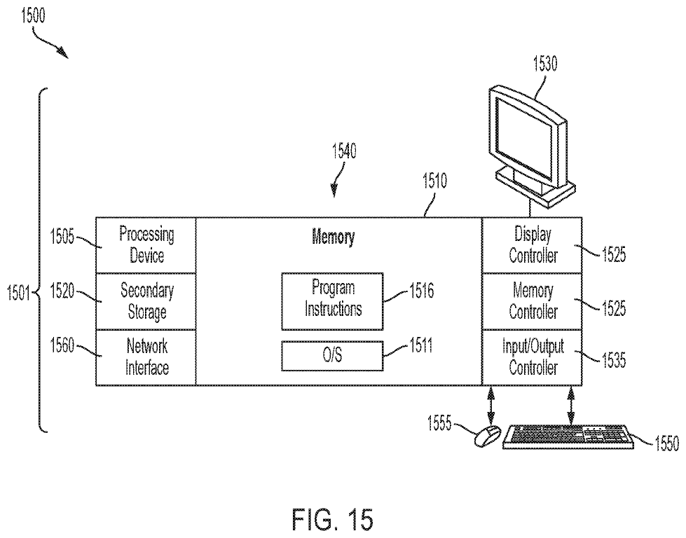

The user device 104 shown in FIG. 1 includes a user module 118 having computer instructions for providing the visual support system to a user 102. The user device 104 also includes a display 114 for displaying the workout to a user 102 and a camera 116 for capturing images of the user performing the workout when the user 102 is in the field of view (FOV) of the camera 116. The user device 104 shown in FIG. 1 can be implemented by any mobile or stationary computer device known in the art such as, but not limited to a laptop computer, a desktop computer, a tablet, or a mobile telephone. Though not shown in FIG. 1, the user device 104 can also include an input device such as a touch screen, a keyboard, and/or a mouse to allow the user 102 to interact with the user module 118, camera 116, and/or display 114. In accordance with one or more embodiments of the present invention, the user device 104 is implemented by a device such as computer 1501 of FIG. 15.

The camera 116, display 114, and input device can be built into the user device 104 as shown in FIG. 1, or one or more of them can be attached externally. For example, the camera 116 may be a web camera and the input device may be a USB keyboard.

Computer instructions to perform functions of the visual support system utilized by the user 102 can be contained in the user device 104 as shown in FIG. 1. Alternatively, all or a subset of the computer instructions of the user module 118 can be located in one more locations remote from the user device 104 and accessed via one or more wired or wireless networks using any manner known in the art such as, but not limited to a web browser and a mobile application.

The coach device 128 shown in FIG. 1 includes a coach module 126 having computer instructions for providing the visual support system to a practitioner, such as a coach 130. As shown in FIG. 1, the coach device 128 also includes a display 122 and a camera 124.

The coach device 128 shown in FIG. 1 can be implemented by any mobile or stationary computer device known the art such as, but not limited to a laptop computer, a desktop computer, a tablet, or a mobile telephone. Though not shown in FIG. 1, the coach device 128 also includes an input device such as a touch screen, a keyboard, and/or a mouse to allow the coach 130 to interact with the coach module 126, the camera 124, and/or the display 122. In accordance with one or more embodiments of the present invention, the coach device 128 is implemented by a device such as computer 1501 of FIG. 15.

The camera 124, display 122, and input device can be built into the coach device 128 as shown in FIG. 1, or one of more of them can be attached externally. In addition, computer instructions to perform functions of the visual support system utilized by the coach 130 can be contained in the coach device 128 as shown in FIG. 1. Alternatively, all or a subset of the computer instructions of the coach module 126 can be located in one more locations remote from the coach device 128 and accessed via one or more wired or wireless networks using any manner known in the art such as, but not limited to a web browser and a mobile application.

As used herein, the terms “via a camera of a user device” refers to a camera that is integrated into the user device, or to a camera that is remote from the user device (e.g., a web cam or other camera) and accessed via computer instructions executing on the user device. Similarly, the terms “via a display of a user device” refers to a display that is integrated into the user device, or to a display that is remote from the user device and accessed via computer instructions executing on the user device.

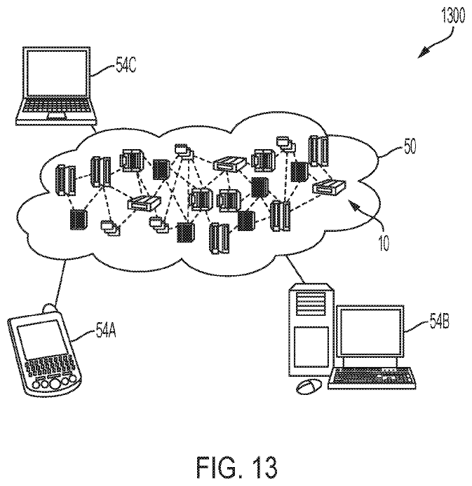

The score/report module 106 shown in FIG. 1 generates score/report data 112 as described herein by comparing the captured image data 110 with the images in the workout data 108. All or a portion of the computer instructions of the score/report module 106 can be located and/or executed on one or more user devices 104, one or more coach devices 128 and/or on one or more other processors remote from the user device 104 and the coach device 128. For example, the score/report module 106 can be located on a cloud computing node 10 of FIG. 13.

In accordance with one or more embodiments of the present invention, the workout data 108 includes individual exercise, or motion, images entered into the system by a practitioner. In accordance with one or more embodiments of the present invention, the workout data 108 is stored in an image format which includes but is not limited to digital video images such as MP4. The workout data 108 also includes exercise plans or workouts for one or more clients that each include one or more of the images of individual motions. The workout data 108 can be stored in any configuration known in the art (e.g., relational database, file system, etc.). In addition, one or more copies of all or a portion of the workout data 108 can be stored in a central location or distributed in any manner known in the art. In one example, a copy of a workout for the user 102 is stored on the user device 104, and another copy is stored on the coach device 128 along with templates of workouts and motions that the coach 130 uses often when creating workouts. The coach 130 can access remotely stored workout data 108 for new exercises or workouts.

In accordance with one or more embodiments of the present invention, the captured image data 110 includes images of the user 102 performing the motions. In accordance with one or more embodiments of the present invention, the captured image data 110 is stored in an image format which includes but is not limited to digital still images such as JPEG, PNG, or GIF. Similar to the workout data 108, the captured image data can be stored in any configuration known in the art and can be centrally stored or distributed in any manner known in the art. In accordance with one or more embodiments of the present invention, the score/report data 112 includes reports about workout activity of users 102 as well as scores indicating a degree of compliance with the prescribed workout. Similar to the workout data 108 and the captured image data, the score/report data 112 can be stored in any configuration known in the art and can be centrally stored or distributed in any manner known in the art.

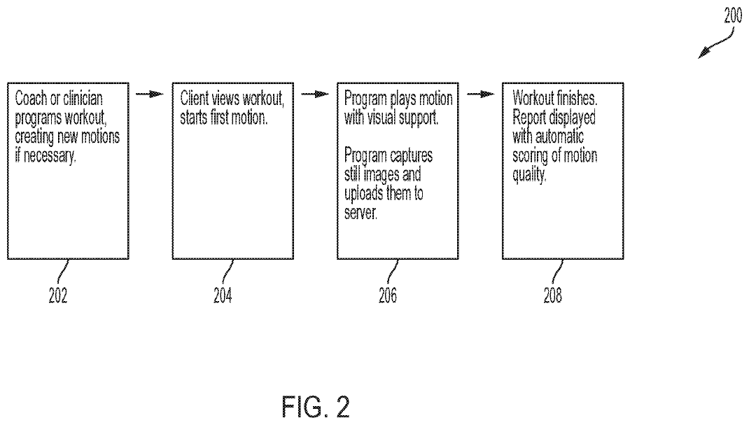

Turning now to FIG. 2, a flow diagram of a method 200 for providing visual support for exercise compliance is generally shown in accordance with one or more embodiments of the present invention.

At block 202, a practitioner, such as coach 130 of FIG. 1, programs a workout for a client, such as user 102 of FIG. 1. The programming can include creating new motions if needed. All or a portion of the processing at block 202 can be performed, for example, by the coach module 126 of FIG. 1 executing on the coach device 128 of FIG. 1 and/or on a processor located on a cloud computing node 10 of FIG. 13. Using a workout interface to the visual support system, provided for example by coach module 126 of FIG. 1, the practitioner creates personalized workouts for clients by selecting the appropriate exercises and specifying how they are combined into a workout, using such attributes such as the number of sets, repetitions, target cadence, recommended resistance levels, and total time required (if applicable). The personalized workouts can be stored as workout data 108 of FIG. 1.

At block 204, a client, such as user 102 of FIG. 1, views the workout and starts the first motion indicated in the workout. All or a portion of the processing at blocks 204 and 206 can be performed, for example, by the user module 118 of FIG. 1 executing on the user device 104 of FIG. 1 and/or on a processor located on a cloud computing node 10 of FIG. 13. At block 206, the visual support system plays the images (which display motions) from the workout and outputs the images to a display of the user, such as display 114 of FIG. 1. When performing a workout, the user positions himself in the field of view (FOV) of a camera, such as camera 116 of FIG. 1, so that their body is aligned with the body of the model shown performing the motions in the workout images. The camera can capture images of the user performing the corresponding motions in the workout. The visual support system captures the images of the user, and then can upload the captured images to a server for storage, for example as captured image data 110 of FIG. 1.

At block 208, the workout finishes, and a report is displayed with automatic scoring of motion quality. In accordance with one or more embodiments of the present invention, a report and a score are generated by score/report module 106 of FIG. 1. The report and score are displayable at both the display 114 of the user device 104 and the display 122 of the coach device 128. In accordance with one or more embodiments of the present invention, the scoring is performed using existing pose recognition algorithms such as, but not limited to OpenPose or PoseNet to determine how close the user's motions are to the modeled motions.

The process flow diagram of FIG. 2 is not intended to indicate that the operations of the method 200 are to be executed in any particular order, or that all of the operations of the method 200 are to be included in every case. Additionally, the method 200 can include any suitable number of additional operations.

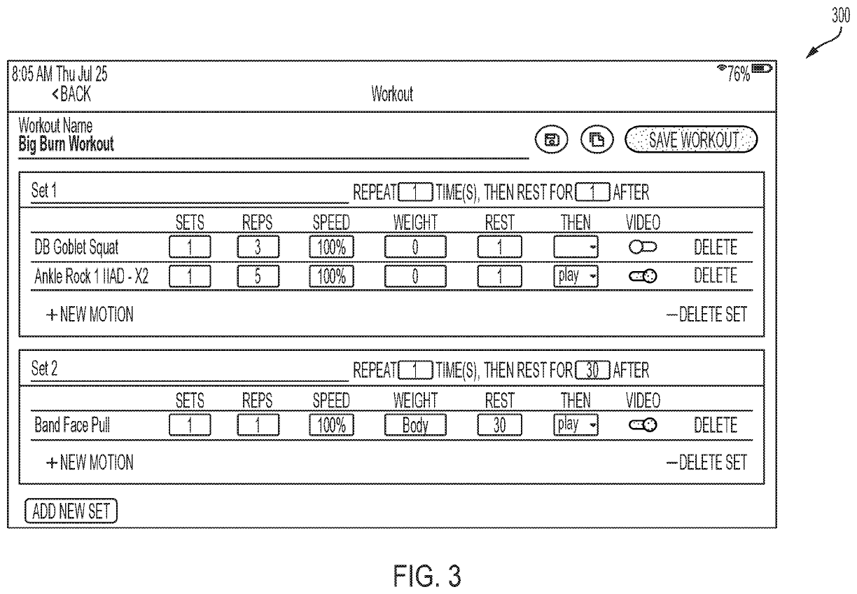

Turning now to FIG. 3, an interface 300 for a practitioner to create or update a client workout program is generally shown in accordance with one or more embodiments of the present invention. The creating or updating a workout can be performed, for example, by coach module 126 of FIG. 1 and the interface 300 can be displayed, for example, on display 122 of coach device 128 of FIG. 1. As shown in FIG. 3, the practitioner can select individual exercises either from a pre-recorded library, such as workout data 108 of FIG. 1, or they can create one or more new exercises. The selected and/or created exercise, or motions, can be combined into a customized workout for a client. Also as shown in the embodiment of FIG. 3, the practitioner can specify the number of repetitions, how they are combined into sets, and the amount of rest time between workout steps, as well as when workouts should automatically proceed or pause. The practitioner also has options to specify the speed and resistance of each motion.

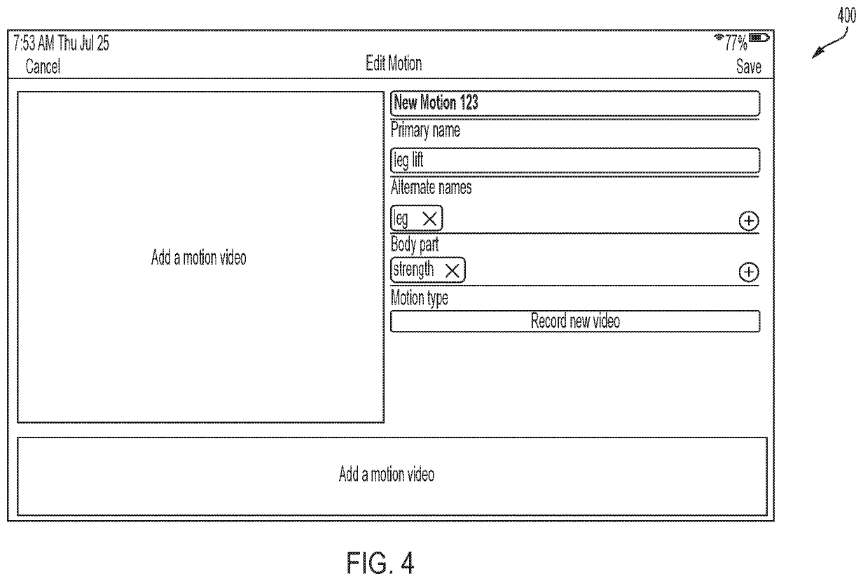

Turning now to FIG. 4, an interface 400 for a practitioner to create a new motion is generally shown in accordance with one or more embodiments of the present invention. The creating a new motion can be performed, for example, by coach module 126 of FIG. 1, and the interface 400 can be displayed, for example, on display 122 of coach device 128 of FIG. 1. When creating a new exercise, the practitioner sets up the device in the best position for the camera to record the exerciser's motion. This can include, for example, positioning a camera, such as camera 124 of FIG. 1, so that the model performing the exercise (e.g., the practitioner) is in the FOV of the camera. In accordance with one or more embodiments of the present invention, the practitioner is prompted to begin the recording and then has a programmable amount of time (e.g., 3 seconds) to get into the starting position in the FOV of the camera.

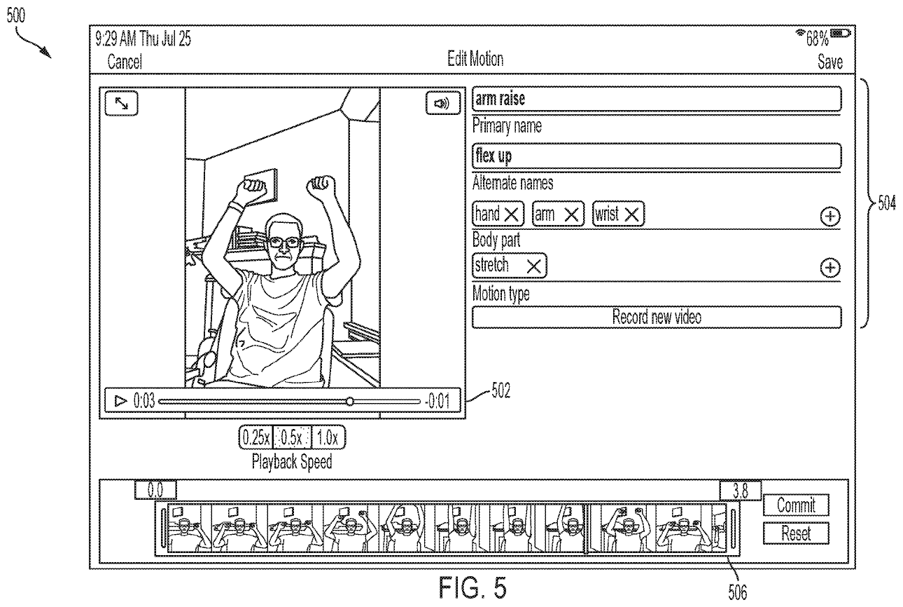

Turning now to FIG. 5, an interface 500 for a practitioner to add a video of one repetition of a motion, which can then be used iteratively to display that motion is generally shown in accordance with one or more embodiments of the present invention. The adding a new video can be performed, for example, by coach module 126 of FIG. 1, and the interface 400 can be displayed, for example, on display 122 of coach device 128 of FIG. 1. The practitioner will perform one repetition, which the system will record. The interface 500 shown in FIG. 5 includes a recording section 502, a metadata section 504, and a still frame section 506 showing portions of the recorded video in recording section 502. In accordance with one or more embodiments of the present invention, the practitioner stops the recording by touching the screen on the device, and has the ability to review the recording and manually edit the video to remove any recorded material not related to the motion (e.g., the practitioner getting up to stop the recording). When the edits are completed, the practitioner can save the exercise to the library of exercises and optionally add it to the client's workout program. In accordance with one or more embodiments of the present invention, the exercise and workout program are stored as workout data 108 of FIG. 1.

One or more embodiments of the present invention provide rapid definition of a new motion by taking video of one repetition and then cropping it, such that the program can later loop it an arbitrary number of times.

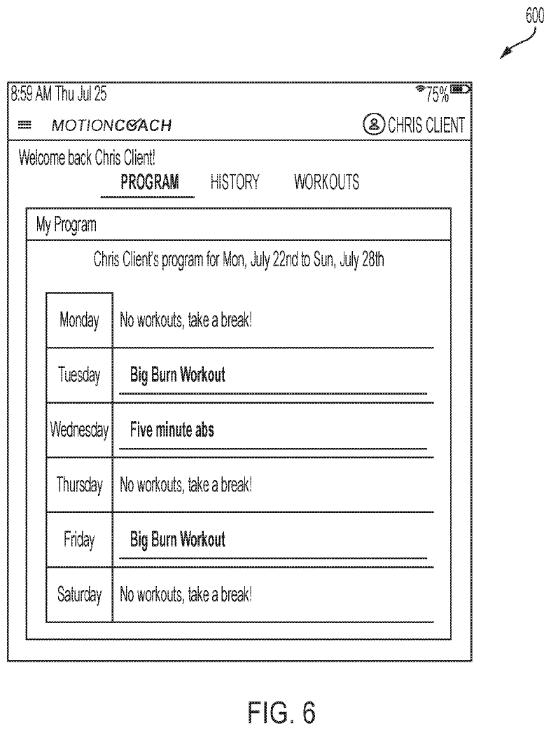

Turning now to FIG. 6, an interface 600 where the client can see their assigned workout program and initiate a workout is generally shown in accordance with one or more embodiments of the present invention. In accordance with one or more embodiments of the present invention, when a client, such as user 102 of FIG. 1, logs in to her account, via user module 118 of FIG. 1 for example, she sees the workouts assigned by the practitioner on a display screen, such as display 114 of FIG. 1.

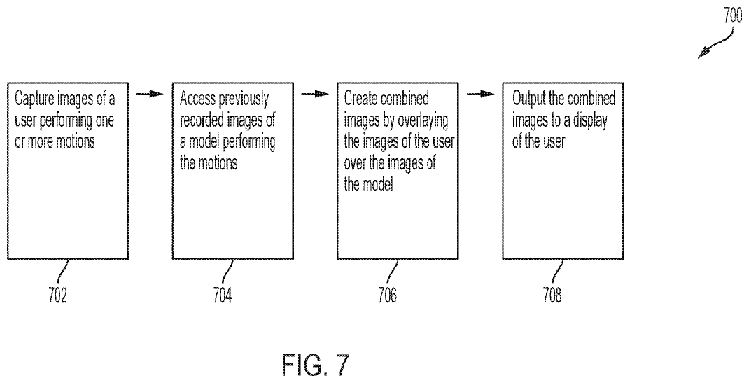

Turning now to FIG. 7, a flow diagram of a method 700 for providing a visual support system for exercise compliance is generally shown in accordance with one or more embodiments of the present invention. All or a portion of the processing shown in FIG. 7 can be performed, for example, by a user program, such as user module 118 of FIG. 1 executing on user device 104 of FIG. 1 and/or on a processor located on a cloud computing node 10 of FIG. 13.

At block 702, a camera captures images of a first person (e.g., a client), such as user 102 of FIG. 1, performing one or more motions. At block 704, previously recorded images of a second person (e.g., a model), such as coach 130 of FIG. 1, performing the same one or more motions is accessed. In accordance with one or more embodiments of the present invention the one or more motions include an exercise that is in a workout selected for the client. The client positions his device similarly to how the model positioned their device while creating the exercise to be followed. At block 706, a combined image that includes both the captured images of the client and the previously recorded images of the model is created by overlaying the captured images of the client over the images of the model. In one or more embodiments of the present invention, the overlaying is performed by the client looking at the display, which includes both the real-time captured images of the client and the previously recorded images of the model and aligning his body with the image of the model. In this manner, the captured images of the client currently performing the one or more motions is overlaid on the previously recorded images of the model performing the one or more motions. The processing at blocks 702, 704, and 706 are performed in an iterative and overlapping manner for the length of time that it takes to display the pre-recorded images (e.g., one minute, thirty minutes, one hour). The processing occurs in real-time as the client is performing the one or more motions. At block 708, the combined image is output to a display of the client to guide the client through the motions.

Aspects are directed to visual support for exercise compliance including capturing, via a camera of a user device, images of a first person performing one or more motions. Previously recorded images of a second person performing the one or more motions are accessed via the user device. Combined images are created by overlaying the images of the first person performing the one or more motions on the images of the second person performing the one or more motions. The combined images are output via a display device.

In accordance with one or more embodiments of the present invention, the one or more motions include a plurality of sequential stages (e.g., each sub-motion with a motion or exercise). The combined image that is displayed to the user includes the client and the model at the same stage of the one or more motions so that their motion at the stage should match if the client is performing the motion as prescribed by the practitioner.

In accordance with one or more embodiments of the present invention, at least a portion of the creating of combined images at block 706 is automated using pose recognition algorithms to match one or more body points (e.g., a particular joint, the heads) on the previously recorded images of the model to a body point on the captured images of the client. The client is still required to be in the FOV of the camera in order to capture real-time images of the client's motions, but the visual support system provides assistance in creating the combined image by moving the previously recorded or the live user images in an attempt to match body points of the client and the model. In accordance with one or more embodiments of the present invention, this is done by comparing the position of the client's and model's core body parts, such as hips and shoulders.

In accordance with one or more embodiments of the present invention, the one or more motions correspond to a workout made up of a plurality of exercises.

In accordance with one or more embodiments of the present invention, periodic time-elapsed images of the client are automatically captured and saved by the user program and stored for example, as captured image data 110 of FIG. 1. While workouts are being performed by the client, the software records each set of each exercise and automatically converts the video into still frames at set intervals (e.g., half second intervals, one second intervals, five second intervals, etc.) to create a scrollable filmstrip. The intervals are programmable and can be dynamically adjusted based, for example, on particular practitioners, particular clients, and/or particular motions. The still frames at set intervals can be provided to the client and/or the practitioner to allow a quick review of a client's workout.

In accordance with one or more embodiments of the present invention when clients complete their workouts, they can review and either submit the recording to their practitioner, which if the practitioner has selected this notification method will notify the practitioner to review (remotely and/or during the next in-clinic session with the client), or the client can delete the workout from the database.

The process flow diagram of FIG. 7 is not intended to indicate that the operations of the method 700 are to be executed in any particular order, or that all of the operations of the method 700 are to be included in every case. Additionally, the method 700 can include any suitable number of additional operations.

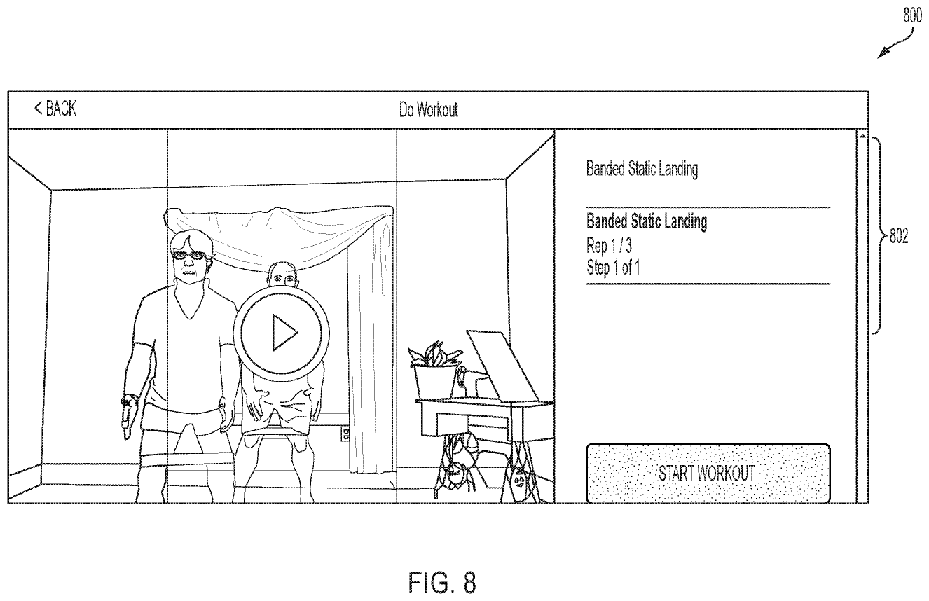

Turning now to FIG. 8, a visual guide 800 for a client to follow when performing a motion is generally shown in accordance with one or more embodiments of the present invention. In accordance with one or more embodiments of the present invention, the client touches the screen on her device to begin the workout, positions herself accordingly, and the follows the model's image on the screen as closely as possible. While performing their workouts, the clients will observe their image overlaid on the model performing the assigned exercises. The visual guide shown in FIG. 8 depicts using an overlaid image of the pre-recorded reference motion (e.g., being performed by the model) with an option to add real-time video overlay of computer pose estimation (e.g., a skeleton view matching joints on the client and model), as additional visual guide. In accordance with one or more embodiments of the present invention, the client can view the computer pose estimation along with the pre-recorded images of the model. The client is stepped through the set number of motions and repetitions 802 prescribed by the practitioner, with the ability to pause or to cancel the workout.

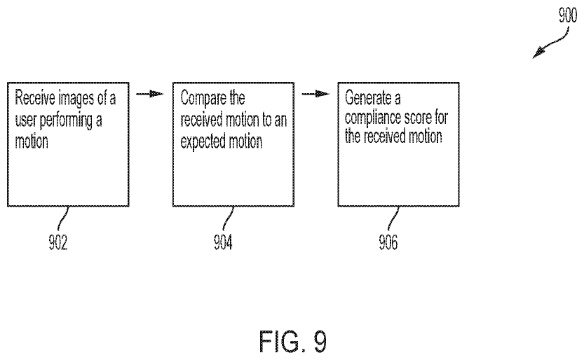

Turning now to FIG. 9, a flow diagram of a method 900 for performing analytic measurement of motion correctness is generally shown in accordance with one or more embodiments of the present invention. All or a portion of the processing shown in FIG. 9 can be performed, for example, by a computer module, such as score/report module 106 of FIG. 1 executing on a computer such as computer 1501 of FIG. 15 and/or on a processor located on a cloud computing node 10 of FIG. 13. At block 902, images of a user performing a motion are received, and at block 904, the received motion is compared to an expected motion. At block 906, a compliance score for the received motion is generated.

In accordance with one or more embodiments of the present invention, the scoring process for comparing the client motion to the model (or coach) motion includes obtaining still images of the client motion and the coach motion, and padding each to make it a square, which corrects for different aspect ratios. Pose estimation algorithms are then used to render each as a pose object, showing position and orientation of all major body parts in the form of X, Y coordinates. Each image's pose is converted to a vector. The vectors are compared by calculating their cosine distance, as implemented by standard and widely available library functions which perform mathematical operations on vectors. The raw numerical result can then be scaled to achieve a 0-100 scaled score. The scaled score can then be displayed, with thresholds such as 65-75 =Okay, 76-85 =Good, and 86+=Great.

The process flow diagram of FIG. 9 is not intended to indicate that the operations of the method 900 are to be executed in any particular order, or that all of the operations of the method 900 are to be included in every case. Additionally, the method 900 can include any suitable number of additional operations.

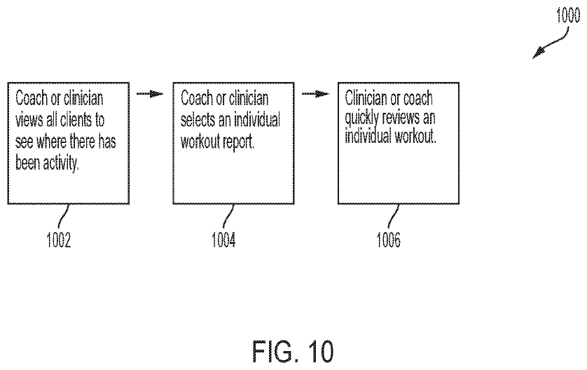

Turning now to FIG. 10, a flow diagram of a method 1000 for performing clinician or coach review of a client workout is generally shown in accordance with one or more embodiments of the present invention. All or a portion of the processing shown in FIG. 10 can be performed, for example, by a computer module, such as coach module 126 of FIG. 1 executing on coach device 128 and/or on a cloud computing node 10 of FIG. 13. At block 1002, a practitioner views all clients to see where there has been activity, and at block 1004 the practitioner selects an individual workout report. At block 1006 the practitioner reviews an individual workout.

The process flow diagram of FIG. 10 is not intended to indicate that the operations of the method 1000 are to be executed in any particular order, or that all of the operations of the method 1000 are to be included in every case. Additionally, the method 1000 can include any suitable number of additional operations.

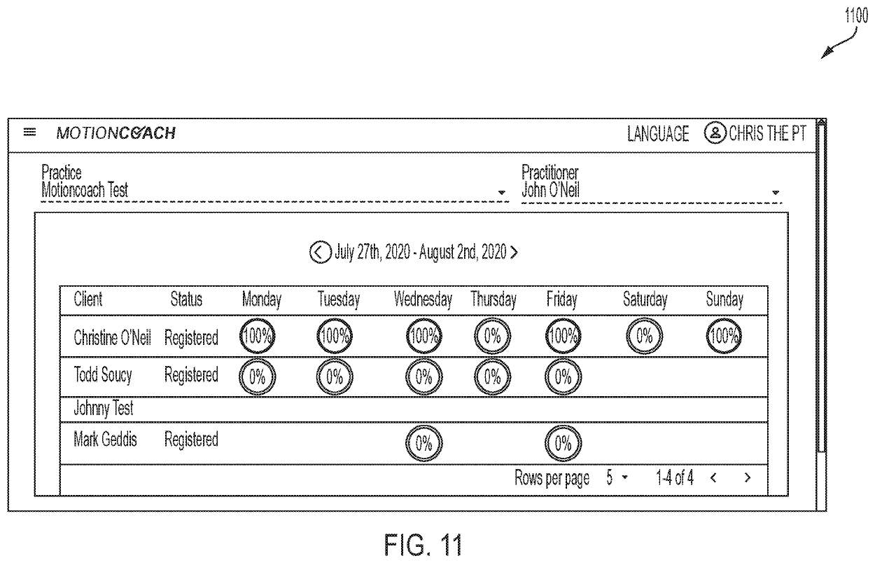

Turning now to FIG. 11, a report 1100 that includes workout status for multiple users is generally shown in accordance with one or more embodiments of the present invention.

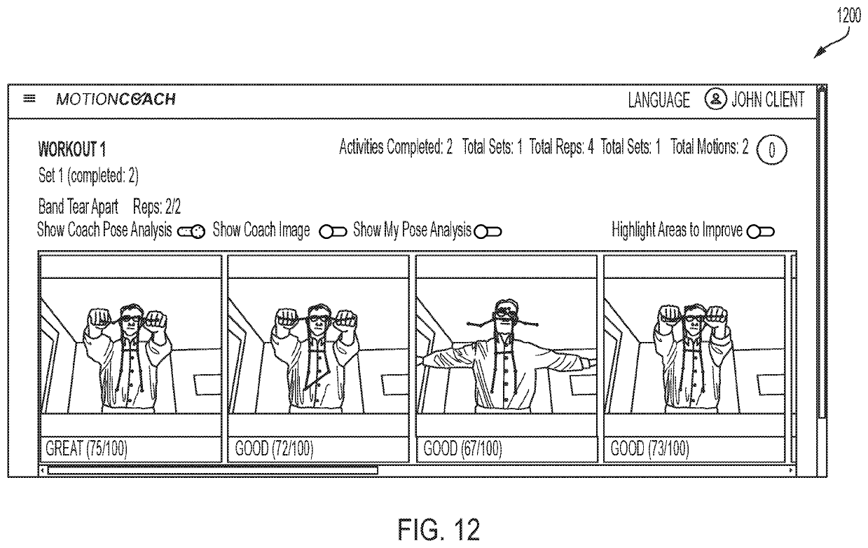

Turning now to FIG. 12, a time lapsed view 1200 of a client's workout is generally shown in accordance with one or more embodiments of the present invention. As shown in FIG. 12, the practitioner can review the filmstrip of the completed workout of a client. FIG. 12 depicts a report of a client's exercise session, using time lapsed images and including a score based on an automatic comparison of computer pose estimations of client and reference figures, using distance between body points as a basis for analytics measuring the quality of client's motion according to one or more embodiments of the present invention. The practitioner can determine quickly if clients are performing their workouts well—both in terms of completion as well as whether they are correct. Analyzing these results will assist practitioners determine the next steps in the course of care, i.e., increase/decrease intensity, increase/decrease frequency, modify the list of exercises, etc.

One or more embodiments of the present invention are implemented utilizing hardware and/or software executing on a computing device such as, but not limited to a laptop device 54C, a smartphone 54A and/or a stationary personal computer 54B as shown in FIG. 13. For example, a smartphone of a client may include the software and hardware required to allow the client to perform the actions described herein related to the client, and a laptop device of a practitioner may include the software and hardware required to allow the practitioner to perform the actions described herein related to the practitioner. In addition, these devices may communicate with each other via a network such as, but not limited to, the cloud network 50 shown in FIG. 13.

It is understood in advance that although this disclosure describes the visual support system for exercise compliance in reference to cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

### Characteristics are as Follows

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

### Service Models are as Follows

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

### Deployment Models are as Follows

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. In essence, cloud computing is an infrastructure made up of a network of interconnected nodes.

Referring now to FIG. 13, an illustrative cloud computing environment is depicted. As shown, cloud computing environment comprises one or more cloud computing nodes 10 with which local computing devices used by cloud consumers, such as, for example, laptop device 54C, smartphone 54A and personal computer 54B may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment to offer infrastructure, platforms and/or software as services for which a cloud consumer does not need to maintain resources on a local computing device. It is understood that the types of computing devices 54 shown in FIG. 13 are intended to be illustrative only and that computing nodes 10 and the cloud computing environment shown in FIG. 13 can communicate with any type of computerized device over any type of network and/or network addressable connection (e.g., using a web browser).

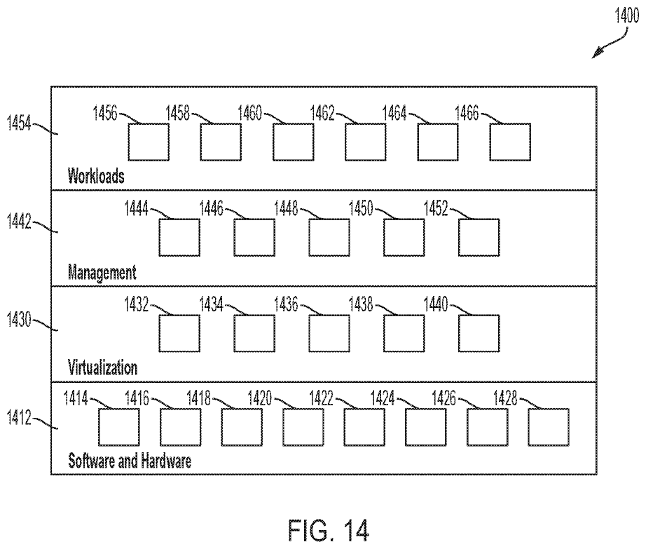

Referring now to FIG. 14, a set of functional abstraction layers provided by the cloud computing environment of FIG. 13 is shown. It should be understood in advance that the components, layers, and functions shown in FIG. 14 are intended to be illustrative only and embodiments of the invention are not limited thereto. As depicted, the following layers and corresponding functions are provided: hardware and software layer 1412 includes hardware and software components. Examples of hardware components include: mainframes 1414; RISC (Reduced Instruction Set Computer) architecture based servers 1416; servers 1418; blade servers 1420; storage devices 1422; and networks and networking components 1424. In some embodiments, software components include network application server software 146 and database software 1428; virtualization layer 1430 provides an abstraction layer from which the following examples of virtual entities may be provided: virtual servers 1432; virtual storage 1434; virtual networks 1436, including virtual private networks; virtual applications and operating systems 1438; and virtual clients 1440.

In one example, management layer 1442 may provide the functions described below. Resource provisioning 1444 provides dynamic procurement of computing resources and other resources that are utilized to perform tasks within the cloud computing environment. Metering and pricing 1446 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 1448 provides access to the cloud computing environment for consumers and system administrators. Service level management 1450 provides cloud computing resource allocation and management such that required service levels are met. Service Level Agreement (SLA) planning and fulfillment 1452 provides pre-arrangement for, and procurement of, cloud computing resources for which a future requirement is anticipated in accordance with an SLA.

Workloads layer 1454 provides examples of functionality for which the cloud computing environment may be utilized. Examples of workloads and functions which may be provided from this layer include: mapping and navigation 1456; software development and lifecycle management 1458; virtual classroom dedication delivery 1460; data analytics processing 1462; transaction processing 1464; and visual support systems for exercise compliance 1466.

Turning now to FIG. 15, a schematic illustration of a system 1500 is depicted upon which aspects of one or more embodiments of a visual support system for exercise compliance may be implemented. In an embodiment, all or a portion of the system 1500 may be incorporated into one or more of the processors described herein. In one or more exemplary embodiments, in terms of hardware architecture, as shown in FIG. 15, the computer 1501 includes a processing device 1505 and a memory 1510 coupled to a memory controller 1515 and an input/output controller 1535. The input/output controller 1535 can be, for example, but not limited to, one or more buses or other wired or wireless connections, as is known in the art. The input/output controller 1535 may have additional elements, which are omitted for simplicity, such as controllers, buffers (caches), drivers, repeaters, and receivers, to enable communications. Further, the computer 1501 may include address, control, and/or data connections to enable appropriate communications among the aforementioned components.

In one or more exemplary embodiments, a keyboard 1550 and mouse 1555 or similar devices can be coupled to the input/output controller 1535. Alternatively, input may be received via a touch-sensitive or motion sensitive interface (not depicted). The computer 1501 can further include a display controller 1525 coupled to a display 1530.

The processing device 1505 is a hardware device for executing software, particularly software stored in secondary storage 1520 or memory 1510. The processing device 1505 can be any custom made or commercially available computer processor, a central processing unit (CPU), an auxiliary processor among several processors associated with the computer 1501, a semiconductor-based microprocessor (in the form of a microchip or chip set), a macro-processor, or generally any device for executing instructions.

The memory 1510 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), flash memory, programmable read only memory (PROM), tape, compact disc read only memory (CD-ROM), flash drive, disk, hard disk drive, diskette, cartridge, cassette or the like, etc.). Moreover, the memory 1510 may incorporate electronic, magnetic, optical, and/or other types of storage media. Accordingly, the memory 1510 is an example of a tangible computer readable storage medium 1540 upon which instructions executable by the processing device 1505 may be embodied as a computer program product. The memory 1510 can have a distributed architecture, where various components are situated remote from one another, but can be accessed by the processing device 1505.

The instructions in memory 1510 may include one or more separate programs, each of which comprises an ordered listing of executable instructions for implementing logical functions. In the example of FIG. 15, the instructions in the memory 1510 include a suitable operating system (OS) 1511 and program instructions 1516. The operating system 1511 essentially controls the execution of other computer programs and provides scheduling, input-output control, file and data management, memory management, and communication control and related services. When the computer 1501 is in operation, the processing device 1505 is configured to execute instructions stored within the memory 1510, to communicate data to and from the memory 1510, and to generally control operations of the computer 1501 pursuant to the instructions. Examples of program instructions 1516 can include instructions to implement the processing described herein in reference to FIGS. 1-14.

The computer 1501 of FIG. 15 also includes a network interface 1560 that can establish communication channels with one or more other computer systems via one or more network links. The network interface 1560 can support wired and/or wireless communication protocols known in the art. For example, when embodied in a user system, the network interface 1560 can establish communication channels with an application server.

In accordance with one or more embodiments of the present invention, display 1530 is a display screen on a smartphone, and the keyboard 1550 and mouse 1555 are replaced by the touchscreen interface of the smartphone.

It will be appreciated that aspects of the present invention may be embodied as a system, method, or computer program product and may take the form of a hardware embodiment, a software embodiment (including firmware, resident software, micro-code, etc.), or a combination thereof. Furthermore, aspects of the present invention may take the form of a computer program product embodied in one or more computer readable medium(s) having computer readable program code embodied thereon.

One or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In one aspect, the computer readable storage medium may be a tangible medium containing or storing a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

The computer readable medium may contain program code embodied thereon, which may be transmitted using any appropriate medium, including but not limited to wireless, wireline, optical fiber cable, RF, etc., or any suitable combination of the foregoing. In addition, computer program code for carrying out operations for implementing aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server.

It will be appreciated that aspects of the present invention are described herein with reference to flowchart illustrations and/or block diagrams of methods, apparatus (systems) and computer program products according to embodiments of the invention. It will be understood that each block or step of the flowchart illustrations and/or block diagrams, and combinations of blocks or steps in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

In addition, some embodiments described herein are associated with an “indication”. As used herein, the term “indication” may be used to refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

“Determining” something can be performed in a variety of manners and therefore the term “determining” (and like terms) includes calculating, computing, deriving, looking up (e.g., in a table, database or data structure), ascertaining and the like.

It will be readily apparent that the various methods and algorithms described herein may be implemented by, e.g., appropriately and/or specially-programmed general purpose computers and/or computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software.

A “processor” generally means any one or more microprocessors, CPU devices, GPU devices, computing devices, microcontrollers, digital signal processors, or like devices, as further described herein. A CPU typically performs a variety of tasks while a GPU is optimized to display images.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device that accesses data in such a database.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

Terms such as processor, controller, computer, DSP, FPGA are understood in this document to mean a computing device that may be located within an instrument, distributed in multiple elements throughout an instrument, or placed external to an instrument.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

The term “about” is intended to include the degree of error associated with measurement of the particular quantity based upon the equipment available at the time of filing the application. For example, “about” can include a range of ±8% or 5%, or 2% of a given value.

1. A method comprising:
capturing, via a camera of a user device, images of a first person performing one or more motions;
accessing, via the user device, previously recorded images of a second person performing the one or more motions;
creating combined images, the creating comprising overlaying the images of the first person performing the one or more motions on the images of the second person performing the one or more motions; and
outputting the combined images via a display of the user device.

2. The method of claim 1, wherein:
the one or more motions comprise a plurality of sequential stages;
a first image in the images of the first person performing the one or more motions and a second image in the images of the second person performing the one or more motions correspond to a same stage of the plurality of sequential stages; and
a combined image of the combined images comprises the first image overlaid on the second image.

3. The method of claim 1, wherein the overlaying comprises matching a body point on the first person to a same body point on the second person.

4. The method of claim 3, wherein the body point is a joint.

5. The method of claim 1, wherein the one or more motions include an exercise.

6. The method of claim 1, wherein the creating is performed in real-time and overlaps with the capturing.

7. The method of claim 1, where the images are in a video format.

8. The method of claim 1, further comprising selecting a subset of the combined images for review by a third person.

9. The method of claim 1, further comprising automatically comparing locations of the images of the first person and the second person in the combined images to measure a quality of the one or more motions by the first person.

10. The method of claim 1, further comprising creating images of a new motion and adding the new motion to the one or more motions.

11. A system comprising:
one or more processors for executing computer-readable instructions, the computer-readable instructions controlling the one or more processors to perform operations comprising:
capturing, via a camera of a user device, images of a first person performing one or more motions;
accessing, via the user device, previously recorded images of a second person performing the one or more motions;
creating combined images, the creating comprising overlaying the images of the first person performing the one or more motions on the images of the second person performing the one or more motions; and
outputting the combined images via a display of the user device.

12. The system of claim 11, wherein:
the one or more motions comprise a plurality of sequential stages;
a first image in the images of the first person performing the one or more motions and a second image in the images of the second person performing the one or more motions correspond to a same stage of the plurality of sequential stages; and
a combined image of the combined images comprises the first image overlaid on the second image.

13. (canceled)

14. (canceled)

15. (canceled)

16. (canceled)

17. A method comprising:
receiving a first plurality of images of a first person performing a motion;
comparing the motion in the first plurality of images to an expected motion;
determining a difference between the motion in the first plurality of images and the expected motion; and
generating a compliance score for the motion based at least in part on the determined difference.

18. The method of claim 17, wherein the expected motion is described in a second plurality of images and the comparing comprises overlaying the first plurality of images with the second plurality of images.

19. The method of claim 18, wherein a stick figure in the second plurality of images is overlaid onto the first person in the first plurality of images.

20. The method of claim 19, wherein locations of joints in the stick figure in the second plurality of images are compared to locations of corresponding joints in the first person in the first plurality of images.

21. The method of claim 17, further comprising updating the expected motion based at least in part of the compliance score.

22. The method of claim 17, wherein the comparing and determining are performed on only a subset of the first plurality of images.

23. The method of claim 17, further comprising:
generating a report comprising at least a subset of the first plurality of images for review by a practitioner via a display.

24. The method of claim 23, wherein the report further comprises a second plurality of images illustrating the expected motion overlaid on the at least a subset of the first plurality of images.

25. (canceled)

26. (canceled)
